(19) United States
(12) Patent Application Publication
(10) Pub. No.: US 2022/0154530 A1
(43) Pub. Date: May 19, 2022

(54) Step Ladder with Hinged Rungs Operable to Collapse on Multiple Axes

(71) Applicant: Jeremy Barker, Morgan, UT (US)

(72) Inventor: Jeremy Barker, Morgan, UT (US)

(21) Appl. No.: 16/219,834

(22) Filed: Dec. 13, 2018

(51) Int. Cl. E06C 1/32; E06C 1/383

(52) U.S. Cl. CPC E06C 1/32; E06C 1/383

(57) ABSTRACT

A ladder having rungs hingedly affixed at both terminal ends to a stringer, the ladder operable to collapse across a lateral or widthwise axis spanned by the rungs, the ladder having hingedly affixed stringers operable to collapse on a lengthwise or longitudinal axis. In some embodiments, a cylindrical tube receives the fully collapsed ladder for stowing and porting.

### FIELD OF THE INVENTION

This invention relates to ladders and stepping implements and more particularly relates to foldable ladders for propping against upright structures.

### BACKGROUND

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Stackable and foldable ladders are well-known in the art and operable in many cases to fold on a lengthwise axis to reduce the length of the ladder in half. Other common ladders telescope and are operable to retract to half, one third, or one fourth of their fully extracted length. Folding ladders offer the conveniences of being collapsible to a compact size for ease of transportation and storage and of being extendible to a variety of lengths and configurations for use as a self-supporting step ladder, a straight extension ladder or as a scaffold.

While these ladders in the art serve the utilitarian purpose of reducing length and improving portability and stowability, the folding ladders in the art remain cumbersome and do not fold or collapse across the widthwise axis spanned by the rungs and also the lengthwise axis spanned by the stringers. There are no ladders known in the art which full collapse across the rungs or which are capable to simultaneously collapsing across two axes to further improve stowability as would be desired by contractors, materialmen and other regularly moving and using ladders.

An object of the present invention is to provide a novel, foldable extension ladder which improves upon the abovenamed disadvantages wherein hinged rungs and joints interlock and collapse

In view of the foregoing, traditional folding ladders are nonoptimal and leave room for more optimal approaches to collapsing and tranporting.

### SUMMARY

From the foregoing discussion, it should be apparent that a need exists for a dampening hinge system that suppresses periodic motions and abrasive wear on a hinge supporting an axial load. The present invention applies various components in novel ways to achieve this. In some embodiments, the connector arms for the hinge system may include bearings, smooth outer surfaces, and tight fittings to help suppress the periodic motions and abrasive wear. Additionally, adjustable mounting apertures provide flexibility during mounting, which reduces stress on the hinge system.

The present invention has been developed in response to the present state of the art, and in particular, in response to the problems and needs in the art that have not yet been fully solved by currently available apparatus. Accordingly, the present invention provides: a collapsible ladder comprising: two or more left side elongate stringers hingedly affixed at a midpoint of the collapsible ladder; two or more right side elongate stringers hingedly affixed at a midpoint of the collapsible ladder; a plurality of rungs having left terminal ends and right terminal ends, the rungs hingedly affixed at each terminal end to a stringer; wherein the ladder is operable to collapse on a longitudinal axis when the ladder is folded at a hinged midpoint; wherein the ladder is operable to collapse on a lateral axis when the left side stringers are moved longitudinally with respect to the right side stringers.

The collapsible ladder may further comprise one or more diagonal braces having a first terminal end hingedly affixed to a stringer and a second terminal end affixed to a rung.

The second terminal end of the diagonal brace may be adapted to travel on the rung. The second terminal end of the diagonal brace may travel on a pully mechanism. The collapsible ladder may further comprise a plurality of feet affixed to a terminal end of a stringer.

The collapsible ladder may further comprise a cylindrical tube adapted to receive the collapsible ladder in a fully-collapsed configuration. The collapsible ladder may further comprise a plurality of ridges adapted to improve nonslip function.

A second collapsible ladder is provided comprising: two or more left side elongate stringers hingedly affixed at a midpoint of the collapsible ladder; two or more right side elongate stringers hingedly affixed at a midpoint of the collapsible ladder; a plurality of rungs having left terminal ends and right terminal ends, the rungs hingedly affixed at each terminal end to a stringer; one or more diagonal braces having a first terminal end hingedly affixed to a stringer and a second terminal end affixed to a rung, the diagonal braces adapted to restrict axial motion of the rungs to less than 90 degrees; wherein the ladder is operable to collapse on a longitudinal axis when the ladder is folded at a hinged midpoint; wherein the ladder is operable to collapse on a lateral axis when the left side stringers are moved longitudinally with respect to the right side stringers.

The second terminal end of the diagonal brace may travel on a pully mechanism. A third collapsible ladder is provided comprising: a plurality of rungs having left terminal ends and right terminal ends, the rungs hingedly affixed at each terminal end to a stringer; wherein the ladder is operable to collapse on a lateral axis when the left side stringers are moved longitudinally with respect to the right side stringers.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A illustrates a side perspective view of fully collapsible ladder with hinged rungs in accordance with the present invention;

FIG. 1B illustrates a forward side perspective view of fully collapsible ladder with hinged rungs in accordance with the present invention;

FIG. 1C illustrates a forward side perspective view of fully collapsible ladder with hinged rungs in accordance with the present invention;

FIG. 1D illustrates a forward side perspective view of fully collapsible ladder with hinged rungs in accordance with the present invention;

FIG. 2 illustrates a forward side perspective view of fully collapsible ladder with hinged rungs in accordance with the present invention;

FIG. 3 illustrates a forward side perspective view of fully collapsible ladder with hinged rungs in accordance with the present invention;

FIG. 4 illustrates a rearward, exploded perspective view of fully collapsible ladder with hinged rungs in accordance with the present invention;

FIG. 5 illustrates a side perspective view of fully collapsible ladder with hinged rungs in accordance with the present invention;

FIG. 6 illustrates a side perspective view of fully collapsible ladder and carrying tube with hinged rungs in accordance with the present invention;

FIG. 7 illustrates a forward perspective view of fully collapsible ladder with hinged rungs in accordance with the present invention; and

FIG. 8 illustrates a side perspective view of an interlocking hinge for foldable ladders in accordance with the prior art.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The flow chart diagrams included herein are generally set forth as logical flow chart diagrams. As such, the depicted order and labeled steps are indicative of one embodiment of the presented method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

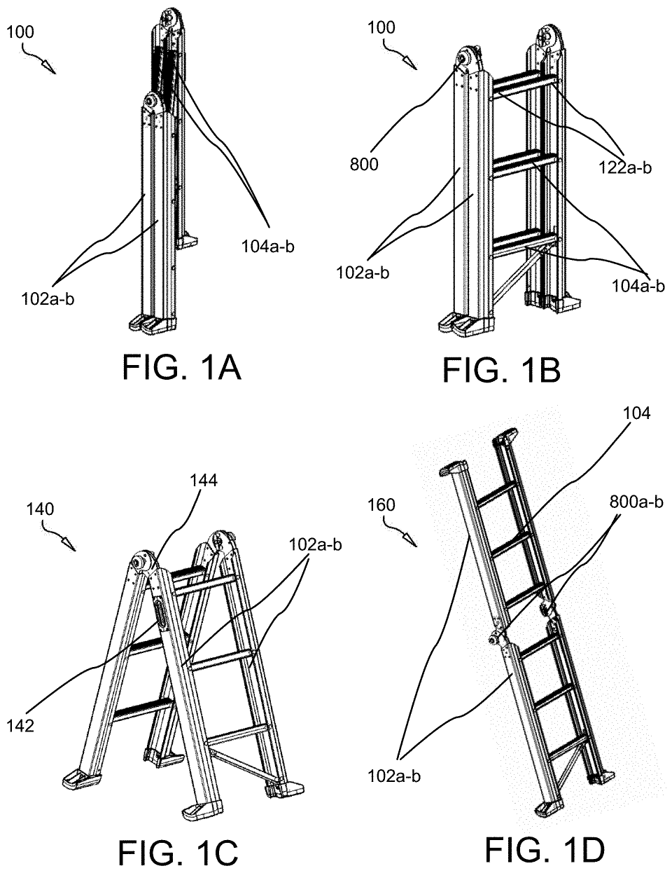

FIGS. 1A-1B illustrate a forward side perspective view of fully collapsible ladder with hinged rungs 100 in accordance with the present invention.

A plurality of rung members 104a-b are hingedly affixed to two or more elongate stringers 102a-b. Each rung 104 comprises two terminal ends 122a-b, with each terminal end 122 hingedly affixed to a stringer 102.

Each of the rung members 104 comprises an elongate shaft, tube, beam, rod, or extruded polymeric or aluminum step or rung portion having a first end terminal end 122a and second terminal end 12b.

The stringers 102 may also be provided with apertures 142 which serve as hand holds for porting the ladder 100.

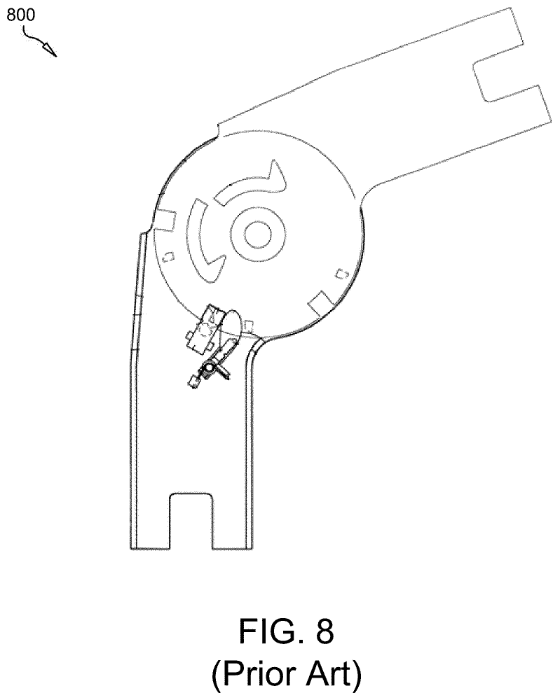

The ladder 100 folds at hinges 800 affixed between adjacent stringers 102. The hinge 800 is known to those of skill in the art, and further described below in relation to FIG. 8.

FIG. 1A shown the ladder 100 in a fully collapsed configuration on both axes while FIG. 1B shows the ladder 100 is semi-collapsed configuration on a single axis. When the ladder 100 is in either a fully collapsed or semi-collapsed configuration, the ladder 100 is operable to collapse on its widthwise axis by moving the stringers 102 along one side of the rungs 104 along the longitudinal axis against the position of the stringers 102 on an opposing side of the ladder 100. The ladder 100 is operable to collapse on both lengthwise and widthwise axes in a semi-collapsed or fully extended position.

FIG. 1C illustrates a forward side perspective view of fully collapsible ladder 140 with hinged rungs in accordance with the present invention.

Shown in an open semi-collapsed position, the ladder 140 may also be folded open at the hinges 800 to configure as a fully-extended position depicted in FIG. 1D.

The ladder 140 is provided with a latching mechanism 144. The latching mechanism 144 may include a simple hinge as known to those of skill in the art or a more complex hinge 800 as further described below.

FIG. 1D illustrates a forward side perspective view of fully collapsible ladder with hinged rungs in accordance with the present invention.

In its fully extended position shown, the ladder 160 is operable to collapse on its widthwise, or lateral, axis by moving the stringer 102 in vertically opposed directions.

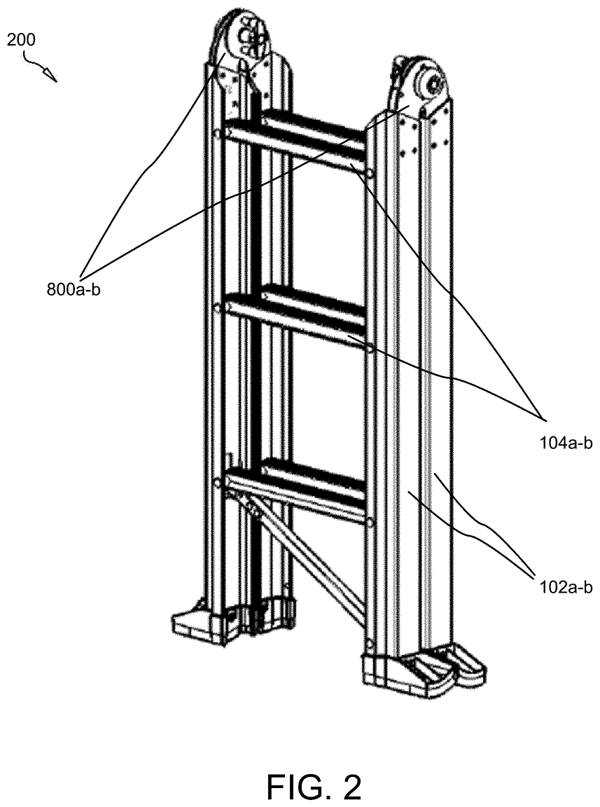

FIG. 2 illustrates a forward side perspective view of fully collapsible ladder 200 with hinged rungs in accordance with the present invention.

The rungs 104 may be formed with ridges, molded or otherwise formed thereon, to increase track and stability of a user positioned on the rungs 104. These ridges 702 act to provide a relatively non-slip surface on the steps. Other non-slip surfaces may be provided instead, as would be evident to a person skilled in the art.

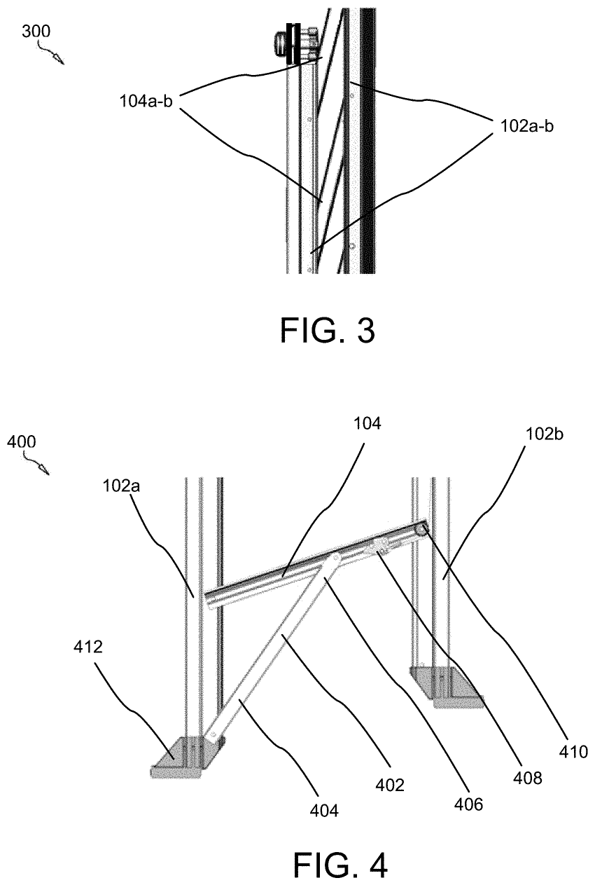

FIG. 3 illustrates a forward side perspective view of fully collapsible ladder 300 with hinged rungs in accordance with the present invention.

The rungs 104 operate to pivot about attachment point with the stringers 102.

FIG. 4 illustrates a rearward, exploded perspective view of fully collapsible ladder 400 with hinged rungs in accordance with the present invention.

In various embodiments, the ladder 400 comprises a diagonal brace 402 which positions beneath each rung 104. The diagonal brace 402 is hingedly affixed at first terminal end 404 to a stringer 102 as shown. At a second terminal end 406, the diagonal brace 402 affixes to one of a rung 104 and/or a pully or track within which the second terminal end 406 travels. The second terminal end 406 may affix to mounting bracket 408 which travels within a traveling mechanism such as the pully 410 shown.

The diagonal brace 402 is adapted to restrict motion of the rung 104 to which the diagonal brace 402 is connected from moving more than 90 degrees. In the shown embodiment, the rung 104 is restricted from axially rotating about its left terminal end in a clockwise direction when the rung 104 is in perpendicular orientation to the stringer 102 from a forward perspective.

The ladder 400 may comprise a plurality of polymeric feet 412.

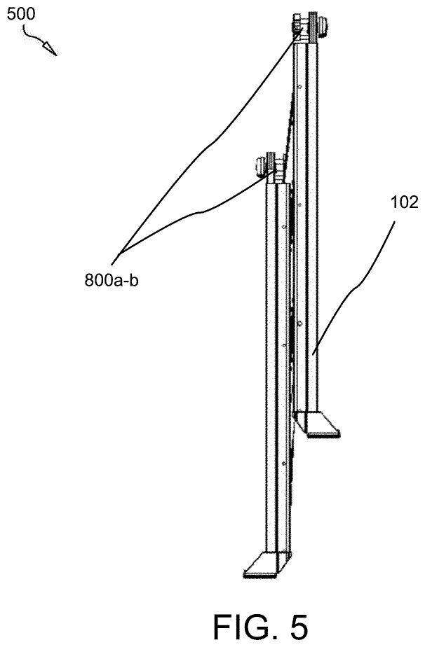

FIG. 5 illustrates a side perspective view of fully collapsible ladder 500 with hinged rungs in accordance with the present invention. The ladder 500 is shown in a semi-collapsed configuration.

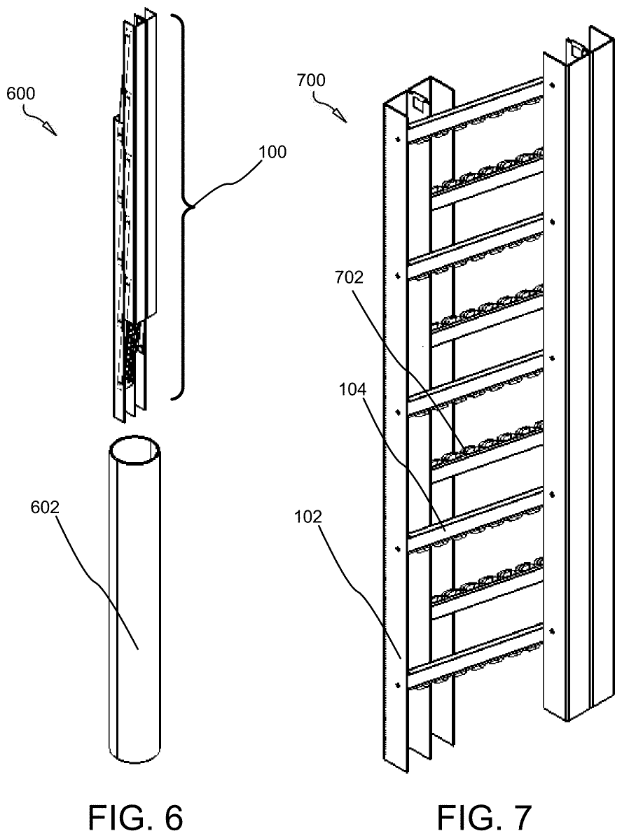

FIG. 6 illustrates a side perspective view of fully collapsible ladder and carrying tube 600 with hinged rungs in accordance with the present invention.

The fully collapsed ladder 100 may insert into a tube 602 which allows the ladder 100 to be ported without unfolding during transport. The tube 602 may cylindrical and formed from polymeric or metal alloy.

If needed, a user can stack multiple fully collapsed ladders 100 one upon one another.

FIG. 7 illustrates a forward perspective view of fully collapsible ladder 700 with hinged rungs in accordance with the present invention.

In various embodiments, the rungs 104 are hingedly affixed to pivot less than 90 degrees off a perpendicular orientation to the stringer 102, with each rung 102 pivoting forward on a vertical (or longitudinal) axis at one terminal end and rearward on the vertical axis at the opposing vertical end.

FIG. 8 illustrates a side perspective view of an interlocking hinge 800 for foldable ladders in accordance with the prior art.

A hinge 800 for foldable ladders known in the prior art comprises a first joint member 10 integrally formed with main discs 13, 14, a second joint member 20 integrally formed with a sub disc 23, a locking device 30 having a button 32, a connecting pin 31, a coil spring 34, a rectangular locking block 33 and a press locking control device 60 for controlling to latch or unlatch the locking device 30. The first and second joint members 10, 20 are combined together through a common axis of a center shaft 50 enabling them to rotate. The sub disc 23 of the second joint member 20 is inserted between a pair of parallel spaced main discs 13, 14 of the first joint member 10. The main discs 13, 14 of the first joint member 10 have slot openings 13a, 13c for inserting the locking device 30. The first protruded arcuate stopper 15 is disposed at the inner surface of the main disc 14. The second protruded arcuate stopper 25 is formed at the rear surface of the sub disc 23 of the second joint member 20 for matching with the first protruded arcuate stopper 15 of main disc 14. A plurality of detents 28 is formed around periphery of the sub disc 23. At one side of slot opening 13c of the main disc 14, a press locking control device 60 is installed for elastically actuating the device.

The hinge 800 may be integrated into a ladder 100 as shown, between two stringer 102. In various configurations, the hinge 800 positions at a midway point on the ladder 100 between two stringers of identical length.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A collapsible ladder comprising:
two or more left side elongate stringers hingedly affixed at a midpoint of the collapsible ladder;
two or more right side elongate stringers hingedly affixed at a midpoint of the collapsible ladder;
a plurality of rungs having left terminal ends and right terminal ends, the rungs hingedly affixed at each terminal end to a stringer;
wherein the ladder is operable to collapse on a longitudinal axis when the ladder is folded at a hinged midpoint;
wherein the ladder is operable to collapse on a lateral axis when the left side stringers are moved longitudinally with respect to the right side stringers.

2. The collapsible ladder of claim 1, further comprising one or more diagonal braces having a first terminal end hingedly affixed to a stringer and a second terminal end affixed to a rung.

3. The collapsible ladder of claim 2, wherein the second terminal end of the diagonal brace is adapted to travel on the rung.

4. The collapsible ladder of claim 3, wherein the second terminal end of the diagonal brace travels on a pully mechanism.

5. The collapsible ladder of claim 1, further comprising a plurality of feet affixed to a terminal end of a stringer.

6. The collapsible ladder of claim 1, further comprising a cylindrical tube adapted to receive the collapsible ladder in a fully-collapsed configuration.

7. The collapsible ladder of claim 1, further comprising a plurality of ridges adapted to improve nonslip function.

8. A collapsible ladder comprising:
two or more left side elongate stringers hingedly affixed at a midpoint of the collapsible ladder;
two or more right side elongate stringers hingedly affixed at a midpoint of the collapsible ladder;
a plurality of rungs having left terminal ends and right terminal ends, the rungs hingedly affixed at each terminal end to a stringer;
one or more diagonal braces having a first terminal end hingedly affixed to a stringer and a second terminal end affixed to a rung, the diagonal braces adapted to restrict axial motion of the rungs to less than 90 degrees;
wherein the ladder is operable to collapse on a longitudinal axis when the ladder is folded at a hinged midpoint;
wherein the ladder is operable to collapse on a lateral axis when the left side stringers are moved longitudinally with respect to the right side stringers.

9. The collapsible ladder of claim 8, wherein the second terminal end of the diagonal brace travels on a pully mechanism.

10. A collapsible ladder comprising:
a plurality of rungs having left terminal ends and right terminal ends, the rungs hingedly affixed at each terminal end to a stringer;
wherein the ladder is operable to collapse on a lateral axis when the left side stringers are moved longitudinally with respect to the right side stringers.

11. A collapsible step ladder comprising:
a top left side rail and a bottom left side rail hingedly affixed at a midpoint;
a top right side rail and a bottom right side rail hingedly affixed at the midpoint;
a plurality of rungs having left terminal ends and right terminal ends, the rungs hingedly affixed at each terminal end to one of the side rails such that said rungs pivot in a uniform direction one with another about a longitudinal plane less than 90 degrees from orthogonal orientation the side rails;
wherein the ladder is operable to collapse when the left side rails and right side rails are moved in opposition to one another on the longitudinal plane such that the left side rails and right side rails come into abutment one with another in a collapsed configuration.

12. The collapsible step ladder of claim 11, where each of the left side rails and the right side rails define an inner recess for receiving the rungs in collapsed configuration.

13. The collapsible step ladder of claim 11, wherein the ladder is operable to collapse when the top side rails and the bottom side rails are pivoted at the midpoint such that the top side rails and bottom side rails come into abutment one with another in a collapsed configuration.

14. The collapsible step ladder of claim 13, wherein the ladder is operable to collapse at the midpoint when a latching mechanism is released.

15. The collapsible step ladder of claim 13, wherein the ladder is operable to collapse at the midpoint when a latching mechanism is released.

16. The collapsible step ladder of claim 11, wherein the ladder is operable to semi-collapse in response to the top side rails and the bottom side rails being pivoted at the midpoint such that the top side rails and bottom side rails come into diagonal orientation relative to one another in a semi-collapsed configuration.

17. The collapsible ladder of claim 11, further comprising one or more diagonal braces having a first terminal end hingedly affixed to a side rail and a second terminal end affixed to a rung.

18. The collapsible ladder of claim 17, wherein the second terminal end of the diagonal brace is adapted to travel within a track on the rung.
